(19) United States
(12) Patent Application Publication
(10) Pub. No.: US 2010/0321275 A1
(43) Pub. Date: Dec. 23, 2010

(54) MULTIPLE DISPLAY COMPUTING DEVICE WITH POSITION-BASED OPERATING MODES

(75) Inventors: Kenneth Paul Hinckley, Redmond, WA (US); Raman Kumar Sarin, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,942

(22) Filed: Jun. 18, 2009

(51) Int. Cl. G09G 5/00; H04N 5/225

(52) U.S. Cl. 345/1.3; 345/1.1; 348/207.1; 348/E05.024

(57) ABSTRACT

Described is a multiple display computing device, including technology for automatically selecting among various operating modes so as to display content on the displays based upon their relative positions. For example concave modes correspond to inwardly facing viewing surfaces of both displays, such as for viewing private content from a single viewpoint. Convex modes have outwardly facing outwardly surfaces, such that private content is shown on one display and public content on another. Neutral modes are those in which the viewing surfaces of the displays are generally on a common plane, for single user or multiple user/collaborative viewing depending on each display's output orientation. The displays may be movably coupled to one another, or may be implemented as two detachable computer systems coupled by a network connection.

### BACKGROUND

Multiple-display (typically dual-display) computing devices are used by different types of computer users. Such multiple-display devices can be particularly valuable for accomplishing tasks that have an intrinsic division of labor or concepts, because with multiple displays, users can partition their work between multiple monitors or multiple mobile devices. For example, reading often occurs in conjunction with writing, with frequent cross-referencing between information sources; a dual display facilitates reading and writing. As another example, finding, gathering, and using information from the Web and other sources may take place on one display, so as to not interrupt the user's primary task (e.g., authoring a document) on another display.

However, having multiple displays can cause other issues. For example, a user performing collaborative work and/or making a public presentation using multiple displays needs to carefully consider what information is to be kept private (e.g., on one display) versus what information may be shown publicly (e.g., on another display).

Any multiple-display technology that helps users with their various tasks and issues is thus desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology in which a computing device has a plurality of displays (e.g., two displays), with sensors that detect the displays' relative positions. Sensor handling logic automatically determines a current operating mode based on the relative positions, from among available operating modes. The current operating mode is provided to one or more programs, which output content for rendering on the displays based upon the current operating mode.

Among the various modes are concave modes that correspond to inwardly facing viewing surfaces of both displays. This facilitates viewing from a single viewpoint, whereby the program may output content that is private, for example. Convex modes correspond to the viewing surfaces of both displays facing outwardly, for viewing from two different viewpoints. In such a mode, for example, the program may output private content directed towards one viewpoint, and public content directed towards the other viewpoint. Neutral modes are those in which the viewing surfaces of the displays are generally on a common plane. This facilitates single user viewing or multiple user (e.g., collaborative) viewing, which may vary depending on the orientation of the content being displayed on each display.

In one aspect, the displays are movably coupled to one another by a physical coupling, such as a hinge. The computing device may be two detachable computer systems (e.g., tablet-type computers) coupled by a network connection.

Upon detecting the relative positions of two display screens, an operating mode is selected based upon the relative positions. This mode may be overridden by additional information, such as received by user interaction, or based upon which program or programs are running. If the positions change, the new relative positions are automatically detected, and a new operating mode selected based upon the new relative positions.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for implementing a dual display computing device with multiple operating modes based upon relative positions as detected by sensors for each display.

FIG. 2 is a block diagram showing example components for implementing a dual display computing device with multiple operating modes based upon relative positions as detected by sensors for both displays.

FIG. 3 is a block diagram showing example components for implementing a dual display computing device with two detachable computer systems coupled for communication.

FIGS. 4-16 are representations of various configurations for positioning the dual displays relative to one another, corresponding to various operating modes.

FIG. 17 is a flow diagram showing example steps taken to select an operating mode based upon relative positions of displays.

### DETAILED DESCRIPTION

Various aspects of the technology described herein are generally directed towards a dual-screen computing device (e.g., tablet computer) that is configured to determine relative positioning of its display screens and thereby facilitate lightweight transitions between usage contexts. For example, if one display screen is facing the user and another display screen is facing away from the user, the device determines that the other screen is publicly viewable, and can take appropriate actions, such as to warn the user before outputting content to that display. If the display screens are positioned with left and right display screens like an open book, the device can take a different action, such as to put one page on the left display, and the next page on the right display.

While the examples herein are described in the context of a dual-display device, it is understood these are only examples; indeed, devices with more than two displays may similarly benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and user interaction with computing devices in general.

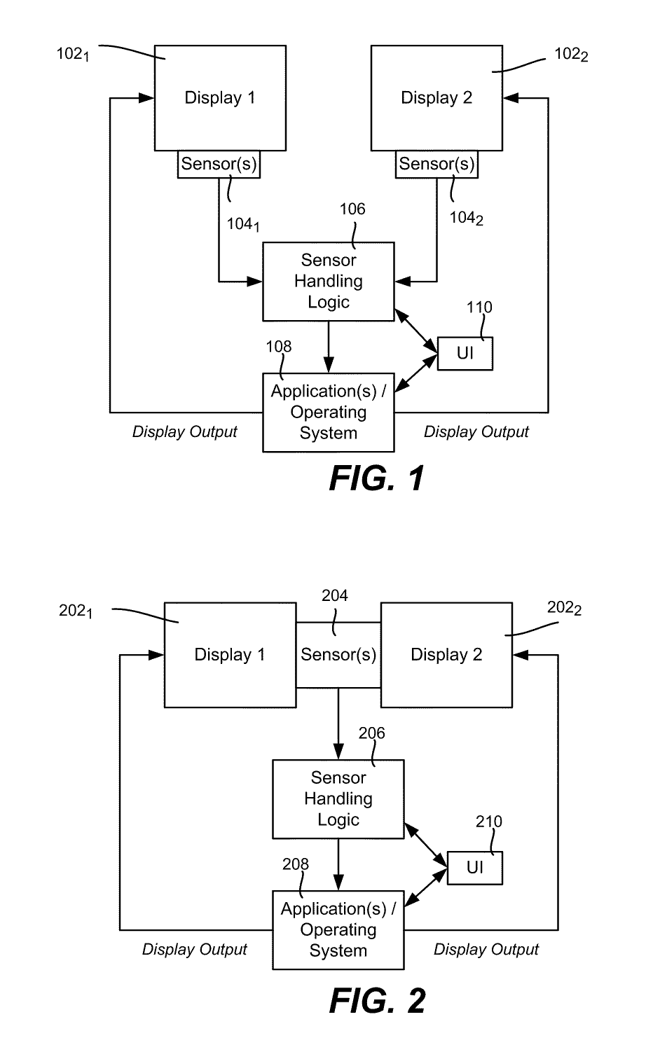

Turning to FIG. 1, there is shown a block diagram of one example computing environment in which a computing device has two displays 102₁ and 102₂. Note that as used herein, the terms “display” and “screen” are interchangeable, and a “display” may or may not be touch-sensitive/configured for inking, that is, like tablet computing devices. However, existing implementations are touch-sensitive/configured for inking, and generally the displays herein are considered to be so. Notwithstanding, any device may be a simple “reader” with both screens only displaying content, one screen may be a tablet while the other is only capable of displaying content, or both screens may be tablets that are touch-sensitive/configured for inking. Further, any device/display may be configured with motion sensing capabilities.

In the example implementation of FIG. 1, each display 102₁ and 102₂ is coupled to a sensor 104₁ and 104₂ , respectively, that detects the positioning (e.g., orientation and angle) of each display relative to the other. Note that while if the illustration the sensors are shown as “touching” the displays, this is not a requirement; for example, the displays may emit signals that are picked up elsewhere and analyzed to determine the relative positions of the displays. This sensed information is fed to sensor handling logic 106, whether by wired and/or wireless communication means.

As can be appreciated, if the displays 102₁, and 102₂ are physically decoupled from one another or movably coupled in some way (e.g., hinged together), there are many relative positions that the displays 102₁ and 102₂ may take, referred to herein as modes or configurations. Based on the current mode/configuration, the sensor handling logic 106 determines an action to take, such as what content or the like one or more applications/operating system components (that is, program or programs 108) may display on each display 102₁, and 102₂ . Note that any of the logic 106 and/or what the program/programs output are user configurable, as represented in FIG. 1 via the user interface (UI) component 110. The UI component 110 may be in the form of a menu or dialog where a user can specify the physical arrangement of the devices to override the sensor inputs. The sensor inputs may be used to suggest a configuration from the available menu of configurations, with the user providing final confirmation to change configurations. Choosing a configuration may also set the screen orientations appropriately, launch instances of applications as necessary, and/or arrange application windows to suit the task.

The programs may support a division of labor between the two screens. For example, a presenter can project slides from one display, while referencing speaking notes, or jotting down thoughts and audience reactions on another display. Page controls on one or both displays screen may be used to remotely control the displays as desired.

One or both screens may support inking (like tablets), and thus may be employed as dual notebook pages by bringing a note-taking application to the forefront on one or both displays. The two displays may show adjacent pages of the same notes, and the page controls may be tied together so that moving to the previous or next page on one tablet performs a corresponding navigation on the other tablet. Notwithstanding, the displays may display different documents or application windows, separate notebooks, different sections of the same notebook, or two arbitrary pages from within the same note.

Thus, device configurations may be explicitly selected by the user or users from a menu, or optionally sensed by accelerometers, touch sensors, contact switches, and other sensors that distinguish between the various possible configurations of the devices. The screen orientation of each device can also be independently controlled automatically or manually, e.g., by pressing a screen rotation button.

For example, if each device (or each half of a single device) contains an accelerometer (e.g., a two-axis accelerometer), the device or devices can automatically detect and configure the screens appropriately, including with the correct viewing orientation. As one example, propping up an upper display while leaving a lower display relatively flat changes the orientation of the upper display. By sharing this information with the lower display, the bottom tablet can change to the appropriate screen orientation, if necessary, even though there has been no change to the physical orientation of that screen. The user or users may also override such automatically sensed transitions, or explicitly select them from a menu, set of icons, or physical buttons provided on each device. Note that to prevent transient states while the user is handling the device or shifting between modes, a change in modes may be suppressed while the device is moving.

Various types of sensors are feasible, including contact sensors, light sensors, and/or microswitches, which can be evaluated to determine useful state information, alone or in combination with other sensors such as accelerometers (e.g., three axis accelerometers, magnetometers, or gyros for motion sensing, a gravity switch/mercury switch for disambiguating the direction of gravity for two-axis accelerometers, and so forth). Other possible sensors include temperature sensors, one or more touch sensors (e.g. capacitive touch sensors), RFID readers and RFID tags embedded in a carrying case and/or the display screens, e.g., including Near Field Communication components. The RFID tag readers may be capable of sensing the proximity of other tagged physical objects as well. Flex sensors, optical encoders, or other means of sensing the angle between screens may also be employed.

The state information that may be sensed includes ambient light/darkness levels, whether a display is mounted to the carrying case or has been decoupled, whether support legs are folded out, whether a keyboard carrying sleeve is attached to the case, and/or whether the power cord pouch is attached to the case. Still further state information includes whether an accessory pouch is closed/zipped shut, whether the case is opened or not, whether the case is fully zipped shut or not, whether each display is connected to AC power or not, whether the case is in a certain configuration, and/or whether a particular edge or surface of a display or the case is resting on a supporting surface. If the unit includes an integrated keyboard or other controls that may be slid out from underneath the display, the keyboard state/position is also sensed. If the unit includes pen input, the unit may sense whether the pen or pens are docked to the unit as well.

As can be readily understood, this state information may be used by the sensor handling logic 106 to determine operating modes/configurations for the programs 108. For example, such state may be used to detect when the two screens are both slid towards the center, for example, to make one large virtual screen (with both keyboards exposed). Another example is that the devices may default to landscape display orientation when the physical keyboard is pulled out (assuming the keyboard is along the long edge of the screen).

In addition, the state information can be used to manage power settings for each display of the device and its subsystems, such wireless (or wired) network communication, the pen digitizer, the touch digitizer, brightness and power to the display, hard disk power state, or standby/hibernation/sleep/full power off states of the processor. For example, the pen digitizer may be turned off if the pen is still docked, with only the touch digitizer active. In some implementations, pen and touch may be sensed by the same digitizer, however.

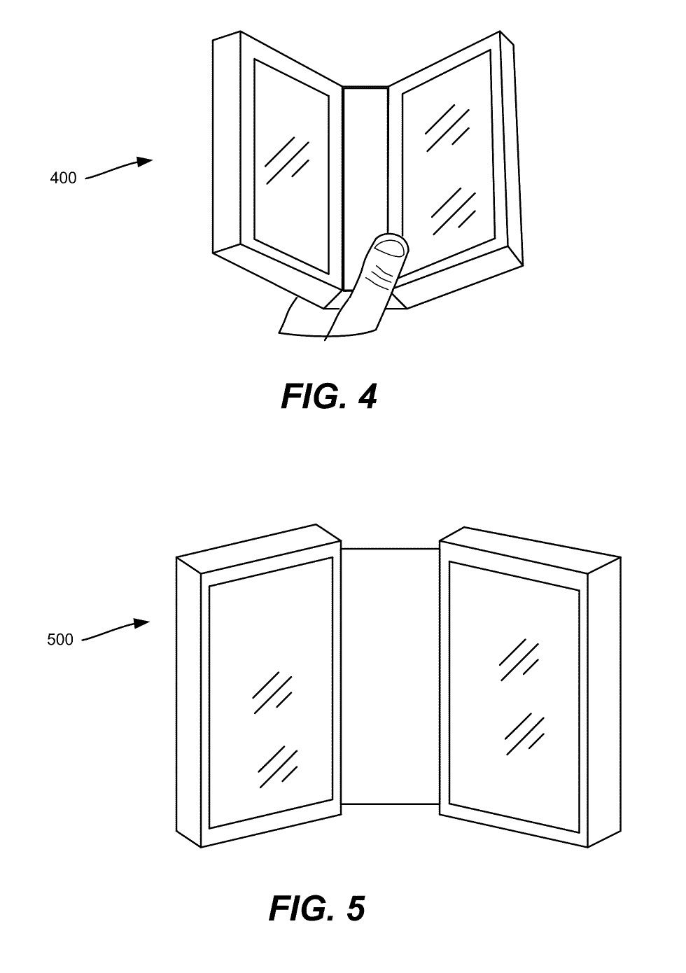

FIG. 2 shows an alternative implementation, in which one set of (one or more) sensors 204 determine the relative positioning of both of the displays 202₁-202₂. One example of such a computing device is wherein the displays 202₁-202₂are physically coupled in a hinged (or double-hinged) arrangement, which may be with distinct detents. The sensor or sensors 204 detect the angle of the hinge, and other attributes that characterize the posture of the displays, as generally exemplified below with reference to FIGS. 4-15.

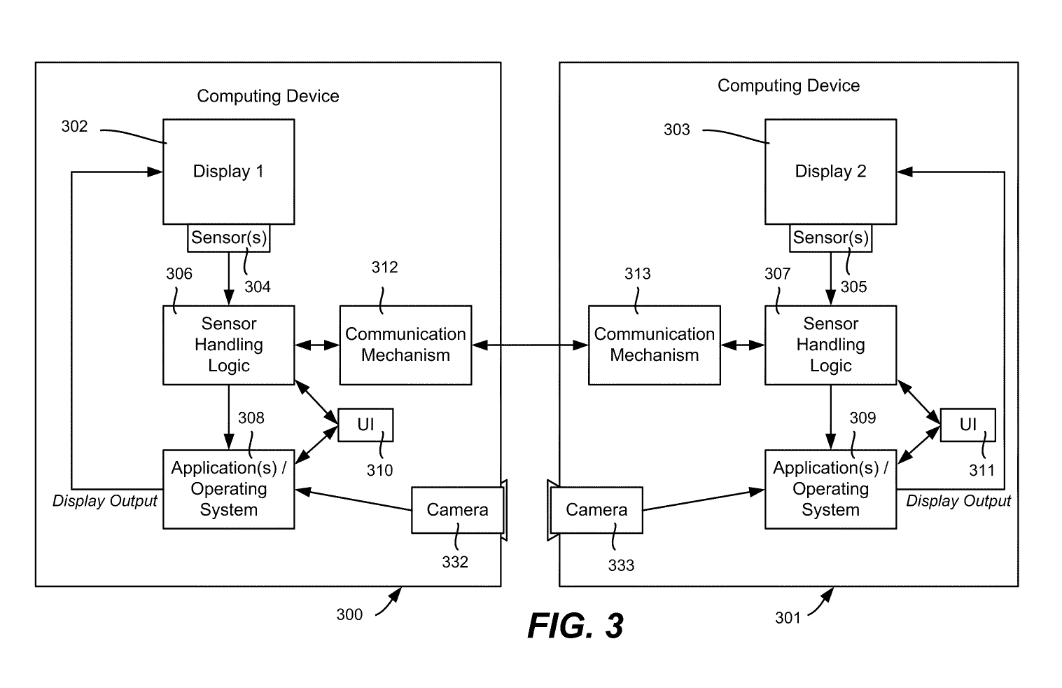

FIG. 3 shows another alternative implementation, in which the displays 302 and 303 are independent computing devices 300 and 301, respectively. As such, each has its own sensors (304 and 305), sensor handling logic (306 and 307), programs (308 and 309) and UI (310 and 311). As shown via the communication mechanisms 312 and 313, the devices 300 and 301 are coupled to exchange information (e.g., wirelessly over some cloud), including positioning data, whereby the sensor handling logic and programs of each can adjust their output accordingly based on their relative positions. In another implementation devices 300 and 301 may have asymmetric capabilities, such that device 300 contains core computational abilities while device 301 is a “thin client” with reduced capabilities (e.g. a low-power display, wireless connectivity, and a smaller battery). In some implementations only one of devices 300 or 301 may be removable from the binding.

In this manner, the devices 300 and 301 may coordinate their actions via wireless (or wired) networking to create the illusion of a dual-screen ink-able notebook or other configuration. For example, each device may run independent instances of a note taking application and share state data via the wireless link.

Thus, the display screens may be part of independent computing devices or realized as a single computing device with a physical or wireless connection between display screens. Further, the device or devices may be a virtual machine that supports disaggregation of individual components via wired or wireless connectivity.

Because the sensors provide relative positioning information, a user may adjust the device as desired to quickly achieve a desirable dual-display configuration directed towards individual work or collaborative interaction scenarios. The user may reconfigure the device to support rapid transitions between a number of other social arrangements, depending on the relationship between the users, the nature of their task, and the social mood.

In one implementation, foldable legs/a support stand may prop the device up at an angle, the device may stand on its own, or the device may lay flat. The device may be two detachable computers systems, each which may be popped up, self standing and/or able to lay flat. Further, the screen orientations are selectable, e.g., between landscape and portrait, and right-side up or upside down.

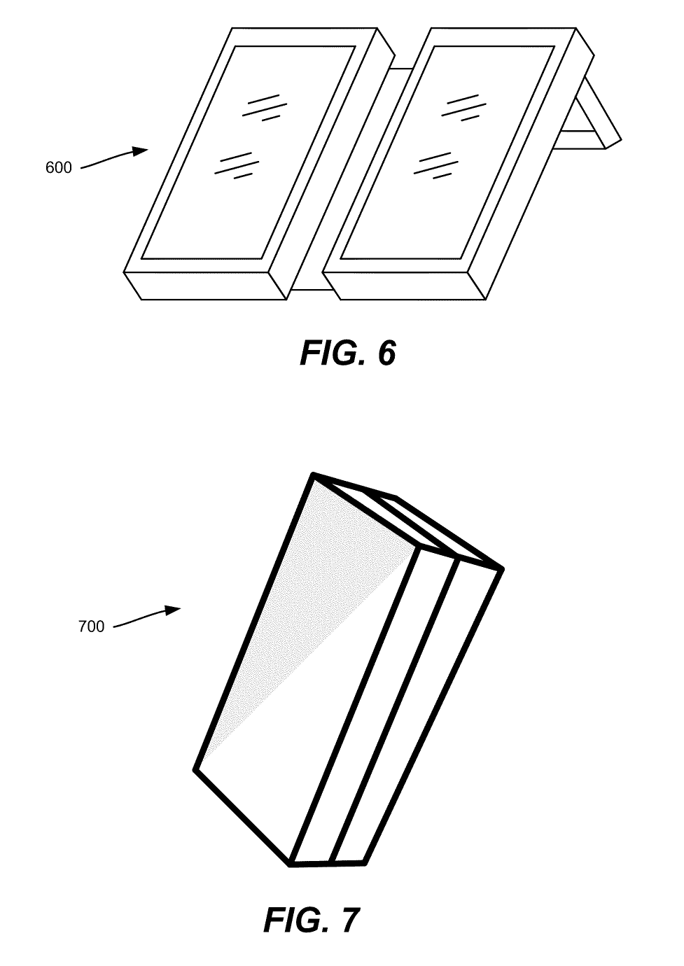

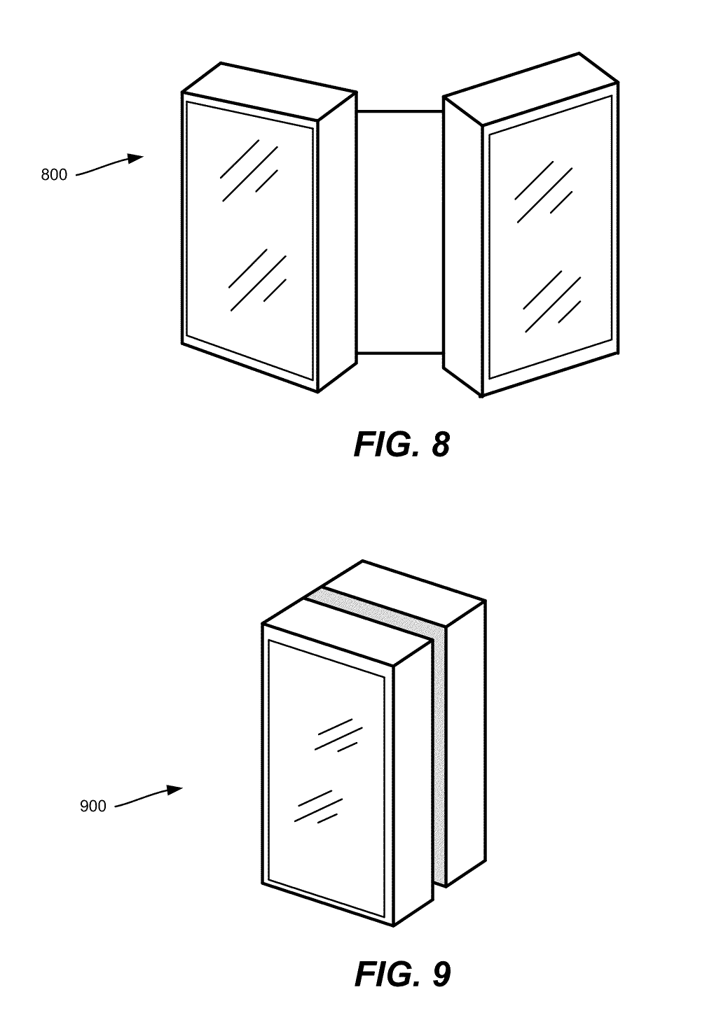

FIGS. 4-17 show some example modes/configurations/postures, including concave modes (e.g., FIGS. 4, 5 and 14) that have inwardly-facing display screens that lend themselves to individual use scenarios, e.g., both of the display's viewing surfaces are visible from a single viewpoint. Convex modes (e.g., FIGS. 8-11) have outwardly-facing screens that afford two users different viewpoints. Neutral modes (e.g., FIGS. 6, 12, 13, 15 and 16) are those where the display's viewing surfaces are on a common plane (e.g., lying flat on with respect to the z-axis such as when the device is laying on a table), at any relative angles while on that (e.g., x-y) plane. Neutral modes are suitable for either single user or collaborative-user tasks, depending on how the screens are oriented.

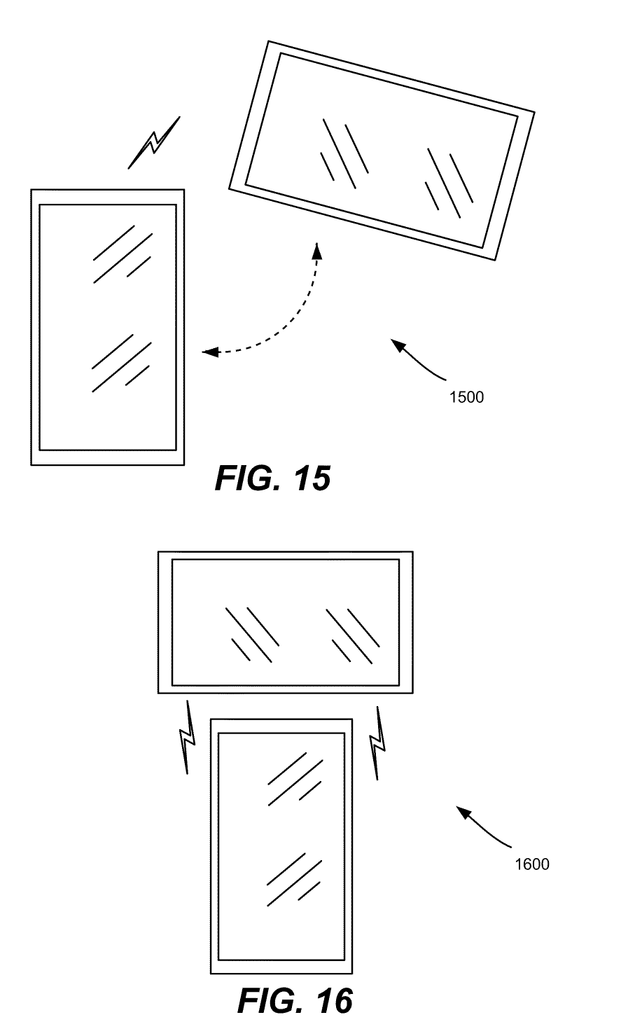

In general, FIGS. 4-6, 12 and 14 show some ways that the screens may be positioned for directing content towards a single user (but not necessarily only one). As such the sensor handling logic and programs ordinarily will consider these to be private usage configurations, unless overridden by the user. FIGS. 8-11 and 13 are more directed towards multiple user-scenarios, and thus are typically considered public (or part public, part private) usage configurations, unless overridden by the user. FIGS. 15 and 16 show modes that are for one or more users, generally depending on the screen orientations.

It should be noted that these figures are not intended to be to scale, nor to show anything other than some of the possible relative positions of two screens. Indeed, as the thickness of screens tends to decrease as screen technology improves, it is likely that extremely thin and/or flexible screens will benefit from the technology described herein, providing for large dual (or more) display devices that are relatively light in weight. Also, the display screens need not be the same size.

FIG. 4 shows a configuration referred to herein as a “book” mode 400, in which both screens are in a portrait orientation, and physically coupled (e.g., hinged) together. In general, the screens may be held similar to a traditional book for reading.

FIG. 5 shows a similar a double-portrait-orientation of the two displays, with the difference being that the device stands alone on a supporting surface. As such, this configuration may be considered a “standing book” mode 500.

As can be readily appreciated, FIGS. 4 and 5 may be used to show adjacent pages as a single user display format. However, this mode may also be employed for multiple users, such as to support shoulder-to-shoulder seating arrangements between users, such as two students studying together. Note that in such situations, it may be desirable to separate the display screens (where configured as in FIG. 3 to do so), and disable automatic sequencing of the pages, so that the two users may navigate independently, with wireless or wired communication maintained across the devices to pass notes, images, or links to documents back and forth between cooperating users, or to support cooperative and/or group searching activities, for example. Moreover, users may use this mode to employ a division of labor between tasks, as commonly seen in usage of multi-monitor systems. As one example, when game playing, the user may have reference material (e.g., cheat codes) on one display and play the game on the other display, such as via touch-screen input, movement detection, and so forth. As another example, information may be passed between displays, as described below.

FIG. 6 shows a “lectern” mode 600 in which both displays lean back in a portrait orientation, supported by legs, a stand or the like. It is alternatively feasible to have a double-landscape orientation lectern mode. Note that while this position has a preferred orientation towards a primary user, it is mostly considered suitable for individual use. Thus by default the sensor handling logic and programs will consider this a single user configuration. However, because the lectern mode may be used for side-by-side collaboration, the user can manually select a “collaborative” option to override the sensor handling logic.

FIG. 7 shows a closed book configuration/mode 700 in which both display screens face one another. This mode is suitable for carrying the device, with the screens facing inwards generally for protection.

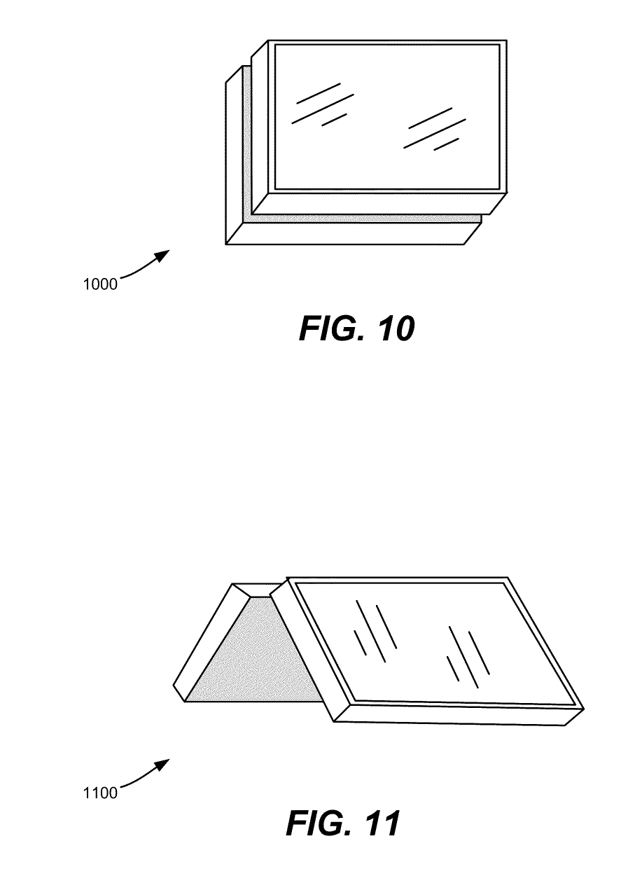

FIGS. 8-10 are other (typically standing) orientations, which may be dual user configurations referred to as a “corner-to-corner” portrait mode 800 (FIG. 8) and face-to-face (outwardly facing) portrait mode 900 (FIG. 9) or landscape mode 1000 (FIG. 10). Note that a “corner-to-corner” landscape mode is feasible, however if the displays are physically coupled the hinge or other coupling needs to be appropriately located. Alternatively the screens can be mounted to a pivot that allows them to be rotated between portrait/landscape orientations.

These arrangements may be directed towards users who may have competing interests, an increased need for privacy, and/or a separation of roles (such as salesperson and client) that makes mutually private displays desirable. However, by changing the position, such as back to those exemplified in FIGS. 4-6, users can quickly and automatically transition to private or cooperative arrangements, and vice-versa. Thus, not only does the device support a variety of viewing configurations, but it also facilitates and automatically handles transitions between physical configurations, making it feasible to modify operation during collaborative activities, without significantly interrupting the natural flow of conversation, for example.

Notwithstanding, the configurations of FIGS. 8-10 may also be used in a “fold-over” mode, similar to a magazine, for example, where a user folds the magazine over to make it easier to hold, and/or to focus their attention on some information, without distraction from other additional information. In this mode, the sensor handling logic can shut down the non-viewed display and temporarily shut it down to save power, for example. Note that the user may configure the action to take in these modes, e.g., private-public displays, or private-powered off displays. Alternatively, the program in use can help in this determination, e.g., a presentation program in any of these modes corresponds to private-public displays, whereas a content reader program corresponds to private-powered off displays.

FIGS. 11 shows a competitive face-to-face mode that is suited for competitive scenarios or games where each user needs to see some information that is hidden from the other user. One example of such a game is the well known “Battleship” game.

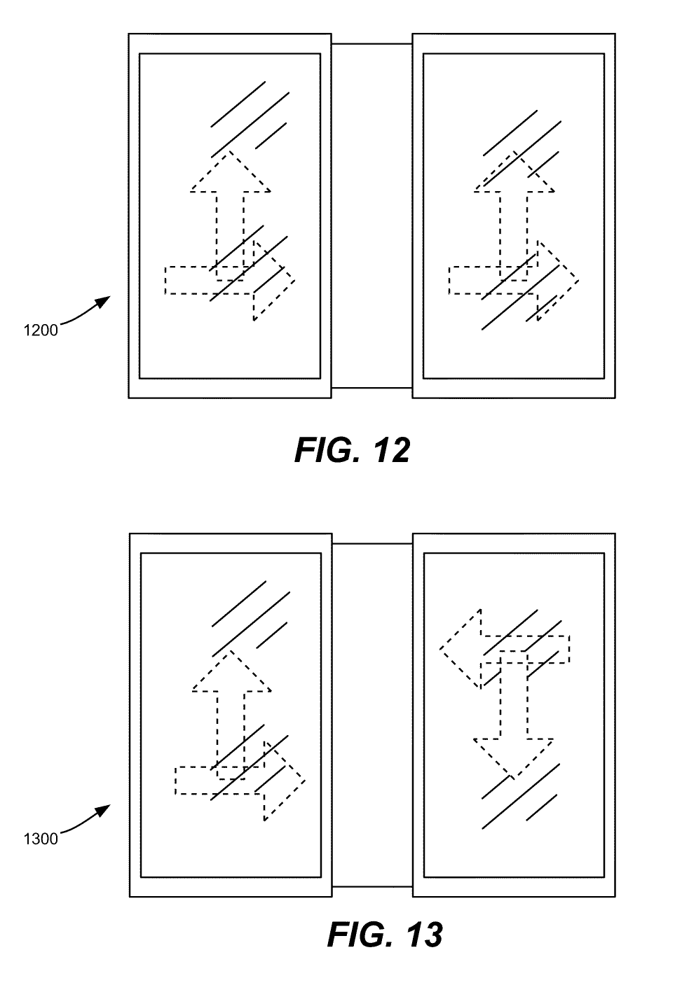

FIGS. 12 and 13 show ways in which the device may be used by a single user and two users, respectively, such as when laid flat on a desk or table. In FIG. 12, the mode 1200 is such that a single user has two screens to use as desired, with the possible screen orientations indicated by the dashed arrows.

In the cooperative face-to-face viewing mode 1300 of FIG. 13, (with the possible screen orientations again indicated by the dashed arrows), one display appears upside-down (180 degree rotation between the screens) so that each user on opposite sides of the device can work with his or her own screen yet see the other screen. The cooperative face-to-face mode thus facilitates cooperation between users because each user can glance at the opposing screen to get an idea of what the other user is doing. Further, software programs may support opening links from one display with the document appearing on the other display, as well as selecting objects and dragging or tossing the selection across the screens. Note that it is also feasible to have one screen portrait oriented and one screen landscape oriented in either the mode 1200 or the mode 1300. Thus, FIGS. 12 and 13 show any mix of horizontal and vertical displays.

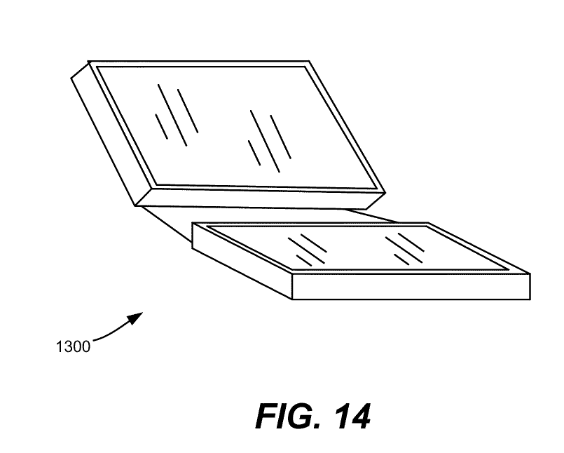

FIG. 14 shows another mode, referred to as “laptop” mode because it resembles an open laptop computer (with a second display instead of a keyboard). The laptop mode supports landscape-format pages. Further, the landscape mode facilitates informal or practice presentations, with the upper (angled) screen displaying public slides, while the presenter controlling the presentation (and jotting private notes) on the lower (generally flat/horizontal) screen. The generally horizontal surface need not be entirely flat, e.g., it can be angled slightly to provide a more ergonomic writing angle.

FIGS. 15 and 16 are directed towards disjoint arrangements of the device, actually two separate devices (e.g., tablets) that communicate to act in a unified manner that is dependent in part on their relative positions. For example, a single user may leverage these modes to view separate documents, much like spreading out multiple physical documents on a desk. In collaborative scenarios, this enables greater flexibility of seating arrangement, and suits tasks where much of the work is done individually, but some coordination or sharing of information between the two halves of the device is still desired. Note that more than two displays such as from additional tablet computers, Smartphones, and other devices including one or more additional dual-display devices may also be associated together via a network connection. This can enable one user to simultaneously view a larger set of documents, or allow multiple users at a meeting the ability to share information and coordinate activities across the group.

As represented in the mode 1500, the devices may be angled in any way relative to one another, with appropriate switching between portrait landscape orientations. As represented in the mode 1600, the devices also may be positioned in any way relative to one another.

By default, the two tablets that comprise the device stay in wireless (or wired) communication. The devices support a transporter mechanism to pass files, ink strokes, links, and so forth back and forth between the devices. If desired, the wireless or wired link between the devices may be closed temporarily, and restored quickly, e.g., by tapping on an icon or selecting a menu command. One user may change the connection, either user may change the connection, or both users may have to agree to change the connection. This may differ on whether a connection is being made or being broken.

Note that while FIGS. 15 and 16 show detached displays, it is also feasible to have similar displays physically coupled in some way. For example, a pivot point, a ring, a tether or the like may allow swinging out one display to various different angles relative to the other, such as for a corner-to-corner collaboration, without allowing the devices to separate. This keeps the displays together, and also allows for a wired communications link between displays (rather than a disaggregated device linked by wireless networking). A single computer may thus output content to both displays.

Turning to another aspect, various functions of the programs can be coordinated and/or specialized between the two displays, depending on the viewing configuration, the display modes and options selected, and the functions triggered in the application. As described above, the operating mode is based upon the physical configuration, the sensor settings, user selected options and preferences, and/or specific commands, gestures, and overrides to configure the screens as desired.

Example software programs that may leverage this technology include note-taking applications, web browsers, word processors, email clients, presentation slide editors, spreadsheets, hierarchical notebooks, an operating system desktop, (e.g., shell, task tray, and sidebar), as well as portions of applications (a ribbon interface, toolbars, command palettes, control panels, different pages, tabs, or views within a document or set of documents, and so forth).

The user has the option to synchronize the clipboards of the two displays, so that anything copied on one device becomes available on the other device. In some configurations, such as the collaborative or disjoint display configurations, this functionality may be disabled by default so that each user can employ their own clipboard; alternatively there may be different clipboards, e.g., a separate clipboard and a shared clipboard useable with respect to each display. When the user pastes (or invokes a “Paste Special” command), the user may be offered the option to paste information from either the local, single-device clipboard, or the shared, multi-device clipboard.

In some applications, various page controls are provided, e.g., previous page/next page controls, tabs for jumping between pages, and bookmarks for pages presented on each screen. Because the software is a program that knows the state or for example two programs that share their state, each display can show an appropriate (e.g., adjoining) page. Selecting a previous/next page may flip through pairs of pages, rather than incrementing the page count one page at a time. This is like flipping through a book, where flipping to a new page presents two new pages of information at once. Split view controls may be available so that each screen can display a separate page, section, or notebook if desired. A simple mode switch icon can toggle between split view and paired view for page navigation (or other application navigation).

The first and last pages may require different handling. One display may be a blank page if the user navigates to the beginning or end of the document on the other display. Alternatively, the software may only allow the left-hand pages to be shown on one device, and the right-hand pages to be shown on the other device.

When editing, other considerations provide a desirable user experience. For example, when inserting a new page, by default the inserted page appears on current screen with which the user is interacting; the other screen keeps displaying its current page, if possible. However, inserting a new page may optionally insert two pages, with both screens displaying a fresh page. Alternatively, another option creates a new page on the current screen, but changes the page viewed on the other screen to maintain the constraint that the screens show adjacent pages in the notebook. Yet another option may change the effect of inserting the new page depending on the screen. For example, inserting a new page from one screen keeps that screen as-is, and inserts the new blank page on the other screen. The other screen may omit the new page insertion function completely, insert two pages, or insert one page and navigate the previous page to the page currently visible on the right screen. Thus inserting can alternatively reflow the remaining pages, or insert a blank page to keep the distinction between left versus right.

Similar issues are considered when deleting a single page. The deleted page may be replaced by a single (blank) page to preserve left page/right page assignments. The effect of page deletion may depend on whether it is initiated and the current mode, e.g., whether it is initiated from the left or the right display relative to the user in a book mode.

Page tabs, if any, that appear at the bottom of the screen optionally may be split, such that the left page displays tabs for even-numbered pages, and the right page displays tabs for odd-numbered pages. Tapping on a page may set the screen to the corresponding page, while informing the other display to display the adjacent page. Hovering over a tab may display a thumbnail of that page, and the thumbnail for the adjacent page that will appear on the other display if the user were to tap the page tab.

The screens may display the same page (e.g. in the collaborative physical configurations), with strokes drawn on one page are sent to the other page by default, to provide shared whiteboard functionality.

Widescreen pages may be supported, with a single double-width page spanning the two devices. When viewed on a single device, such widescreen pages may appear in a scaled-down form that fits on one screen. Pan and zoom controls may also be available for single-device navigation. Other viewing modes, such as two-up page views on each display, may be available as well.

Various controls and other user interface mechanisms such as tool palettes may be displayed as separate instances on each display, or may be customized per display. In a screen capture mode, the captured screen portion is placed on the shared system clipboard, with the capture sent to the page from which the capture function was activated, or alternatively to the most recently used page. If only one screen currently displays such a page, the capture is sent to that page; this is useful for viewing a document on one screen, with the user gathering notes about the document (possibly including screen captures from the document) on the other screen.

In general, each display can share/react to any action taken on the other, with the user able to override any defaults. For example, selecting a pen or highlighter may cause the same pen or highlighter to become active on the other display; optionally, different pens or highlighters may be selected for each display, e.g. to support highlighting existing notes on one page, while jotting down new notes on the other page. Likewise, other tool modes may put both screens in the same tool mode by default (lasso selection, eraser and the like), however this may be overridden, e.g., a check-box may be located in the vicinity of the tool modes to apply the tool to the local display only, or to both displays. A gesture to select the tools may have local versus global variations (e.g. based on pen pressure, making a hitch, loop, or corner during the selection, or making a longer stroke that surpasses the outer boundary of the menus). By default, controls to select a current tool are available on both screens, but the “tool arc” or toolbar that hosts these tools may be hidden on one device, in which case the remaining one on the other display controls both screens.

With respect to UI Snap Points and Alignment Edges, the arrangement of the page, page tabs, margins, etc. may be customized depending on which physical screen a page appears. For example, bookmarks may appear on the right edge of the right-hand screen, but on the left edge of the left-hand screen. The tool arc might default to the top-right corner on the right-hand screen, but default to the top-left (or bottom-left) corner on the left-hand screen.

For hyperlink commands, links may open on the opposite screen by default, so as to encourage a division of labor between the devices, e.g., for note-taking on one display, with supporting materials available on the other screen. However, depending on the current physical configuration, applications, or options selected per user preference, opening a hyperlink on one page can open the linked web page, email, or document on the same screen, or may send the request to display the document to the other screen. For example, opening a hyperlink embedded within a notes page opens a web browser on the opposite screen, but then subsequent links opened within the web browser open the new page on the screen already occupied by the browser. Check-box options, variations in user gestures and so forth can also be employed to control this option.

In one separable, dual-tablet implementation, a “Personal Search” command federates desktop search results from each portion of the device so that the user need not be concerned with which tablet stores the actual file or email. Paths to documents may be encoded such that individual search results can be opened from either device. A check box or other control in the search dialog may allow the user to filter results, by including or excluding results depending on which physical store contains the information.

Each screen may provide for independent selection, e.g., by default, commands (e.g. cut, copy, delete, rotate, and so forth) only affect the selection on the local device, and do not affect any selection on the remote device.

The user may directly drag a selection between the two screens; once the selection passes the bound of the corresponding edge of the displays, it starts to appear on the other device, and may be dragged onto the remote display from there. This may persist as an independent selection on the other device, or it may cause any prior selection to become deselected, with the remotely dragged objects becoming the selection. By default, the semantics of dragging is that the objects are moved, rather than copied, across the network, but in some cases both devices need to maintain a reference to objects in a selection that spans the two screens, or to provide semantically consistent undo functionality. Thus, Undo and Redo may share information so as to take joint action to reverse or repeat certain operations.

The devices may also offer a special region or icon on the screen that serves as a drop target to drag selected objects to the other screen. If the user drags to this drop target and dwells briefly, the content is sent to the other device.

A given system may offer one, both, or neither of these dragging mechanisms.

If each screen displays content from different notes or documents, pages of that content (or hyperlinks to that content) may be sent to the other device, to allow easy creation of notebooks from mixed sources, for example. The page may be sent as a copy of the page or as a reference to the page, e.g., with state synchronized between the two views of the page if subsequent changes are made.

When used as disjoint devices, they may operate independently, as if they were completely separate devices. Select cross-device functionality (e.g. commands to establish a shared whiteboard, send pages or the selection to the other device, and the like) may be present to allow “working independently, yet together” on a project with another user. For example, a “Send Page to Other Screen” button allows a second user to see the same page as a first user. The second user may be offered the option to refuse or defer viewing of the sent page.

The above considerations can be generalized to apply to more than two screens, and/or to a device that contains more than two “pages” that are independent, or between multiple tablets or other devices in an office or meeting room, for example. Techniques such as stitching, bumping, or setting up meeting requests may be used to establish linkages between multiple devices and/or additional tablet and laptop computers. Surface computers, electronic whiteboards, Smartphones, PDA's, and other mobile devices may also participate in such a federation.

The device when disjoint and/or other devices may implement a network file system using any well-known technique that allow network file folders to be treated and accessed as if they were stored locally, even though they may physically exist on the other device, in “the cloud” or on a distributed network of file servers. A device may also employ solutions with physically connected storage systems available on one or both devices.

Other features are also optional and may be provided with respect to a dual-display device. For example, dual web cameras (332 and 333. FIG. 3) may provide a stereo view of one user, or a view of each of two users, depending on the physical arrangement of the devices. Such cameras can also be used to capture photographs of physical objects for inclusion in a page of notes; by default snapshots using the physical camera accompanying one display may be included in a page corresponding to that display. As well as being stamped with time, date and the like, the image may be stamped with the orientation of the camera if accelerometers are available for orientation detection.

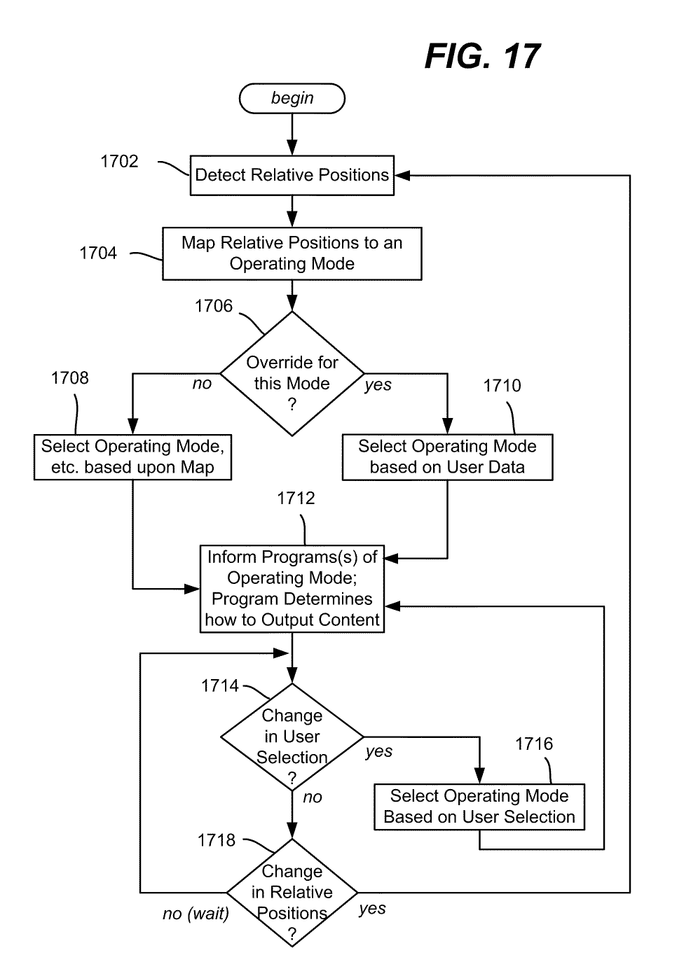

FIG. 17 is a flow diagram representing example steps in a straightforward implementation, beginning at step 1702 where the relative positions of the two screens are detected. These positions may be mapped to a table or the like that maintains information as to which operating mode corresponds to the positions, e.g., any of the modes exemplified above.

Step 1706 represents evaluating whether to override this operating mode. As described above, this may be per user, or per application. For example, a user may want a non-facing (fold-over mode) display powered down for a reader application, whereas the user may want to show public content on that same display when running a presentation application. Thus, for example, the device may be default configured for automatically showing both displays in this mode (as represented in FIGS. 9 or 10), but when the device knows that the reader application is running, a setting may override the default. Note that step 1706 may be automatic, or instead may include a prompt or warning to the user asking whether to override the upcoming mode. Such a prompt may be dependent on the mode, e.g., only prompt when about to display information in one of the public modes.

If the default mode is not overridden, step 1708 selects the operating mode from the mapping or the like. Other information such as portrait or landscape orientation, screen brightness, resolution and so forth may be part of the mode, or may be left up to the program to determine. If the mode is overridden, the mode is selected based on some user-provided data or the like. This may include a user-defined specification of which application(s) or content to view on each screen in a given mode.

Step 1712 represents informing the program or programs regarding the currently selected operating mode. The program may then output content accordingly, e.g., to show adjacent pages, to separately output public versus private content to each display, and so forth.

At any time, the user may change the selected mode via a user interface, gesture and/or other means (e.g., a hardware button). If so, step 1716 changes the mode based on the user selection, and the program or programs are informed of the new current mode at step 1712.

The mode may also change according to a change in the relative positions of the displays, as evaluated at step 1718. If so, the relative positions-to-mode mapping is again consulted (e.g., via steps 1702 and 1704). In this manner, a user may simply adjust the displays and obtain a new operating mode that matches the new relative positions. Although not shown, other state changes may change the mode, e.g., low power, decoupling physically coupled devices, and so on.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising:
a computing device having a plurality of displays;
a sensor set comprising at least one sensor that detects the displays' relative positions;
sensor handling logic that, based on the relative positions, determines a current operating mode of the computing device from among a plurality of available operating modes; and
a program set comprising at least one program that outputs content for rendering on the displays based upon the current operating mode.

2. The system of claim 1 wherein at least two of the plurality of displays are movably coupled to one another by a physical coupling.

3. The system of claim 1 wherein the computing device comprises two detachable computer systems coupled by a network connection.

4. The system of claim 3 further comprising a camera coupled one of the computer systems, or a first camera coupled to a first computer system and a second camera coupled to a second computer system.

5. The system of claim 1 wherein the current operating mode comprises a book mode, and wherein the program set outputs content comprising adjacent pages of a document.

6. The system of claim 1 wherein the current operating mode comprises a mode in which both displays generally face one direction, and wherein the program set outputs content directed towards a single viewpoint.

7. The system of claim 1 wherein the current operating mode comprises a mode in which both displays generally face opposing directions, and wherein the program set outputs private content directed towards one viewpoint and public content directed towards another viewpoint.

8. The system of claim 1 wherein the sensor set comprises at least one two-axis or a three axis accelerometer.

9. The system of claim 1 further comprising means for propping up at least one of the displays at an angle relative to horizontal.

10. The system of claim 1 wherein the current operating mode comprises a mode in which one display faces generally towards a user and one display faces generally away from the user, and wherein the display that faces generally away from the user is powered down based upon the mode.

11. The system of claim 1 wherein the current operating mode is used to determine whether at least one of the displays has a portrait or landscape orientation.

12. The system of claim 1 wherein the current operating mode corresponds to both displays laying flat or generally flat, and wherein further input determines whether the output on the displays is oriented in a same direction or in opposite directions.

13. In a computing environment, a method comprising, detecting relative positions of two display screens, selecting an operating mode based upon the relative positions, and providing data corresponding to the operating mode to a program for outputting visible information to the display screens based upon the operating mode.

14. The method of claim 13 further comprising overriding the operating mode based upon additional information to provide a new operating mode.

15. The method of claim 14 further comprising receiving the additional information via user interaction with at least one of the display screens.

16. The method of claim 14 further comprising determining the additional information based upon at least one running program.

17. The method of claim 13 further comprising detecting new relative positions of the two display screens, and selecting a new operating mode based upon the new relative positions.

18. A computing device comprising, two displays that are moveable relative to one another, a sensor set comprising at least one sensor that detects the displays' relative positions, and sensor handling logic determines an operating mode based upon the displays' relative positions, and the operating modes including at least one concave mode corresponding to viewing surfaces of both displays facing inward relative to one another for viewing from a single viewpoint, at least one convex mode corresponding to the viewing surfaces of both displays facing outward relative to one another for viewing from two different viewpoints, and at least one neutral mode in which the viewing surfaces of the displays are generally on a common plane.

19. The computing device of claim 18 wherein the device includes two detachable computer systems that are coupled with one another for communication, one computer system corresponding to each display, in which at least one of the displays provides its positioning information to the other for determining the relative positions.

20. The computing device of claim 18 wherein the displays are physically coupled to one another.
